(19) United States
(12) Patent Application Publication
(10) Pub. No.: US 2026/0297777 A1
(43) Pub. Date: Oct. 1, 2026

(54) IMPROVING DIAGNOSTIC MEASUREMENTS DURING OPERATION OF ELECTROLYZERS

(71) Applicant: Fourier Earth, Inc., Mountain View, CA (US)

(72) Inventors: Todd J Kazmirski, San Jose, CA (US); Prasanna Mani, Fremont, CA (US)

(21) Appl. No.: 19/348,843

(22) Filed: Oct. 3, 2025

Related U.S. Application Data
(60) Provisional application No. 63/781,382, filed on Apr. 1, 2025.

(51) Int. Cl. C25B 15/023; C25B 1/04; C25B 9/65; C25B 9/73

(52) U.S. Cl. CPC C25B 15/023; C25B 1/04; C25B 9/65; C25B 9/73

(57) ABSTRACT

An aspect of the present disclosure is directed to improving diagnostic measurements during operation of electrolyzers. In one embodiment, a hydrogen production system contains an electrolyzer; a direct current (DC) voltage source to apply a DC voltage across the electrolyzer to cause production of hydrogen by the electrolyzer; a test source to apply an alternating current (AC) signal across the electrolyzer to perform measurement of a diagnostic parameter of the electrolyzer; and a filter located in a path between the DC source and the electrolyzer, the filter designed to block the AC signal from when the AC signal is applied across the electrolyzer. As such the test source is operable to perform the measurement during the production of the hydrogen while the filter prevents the diversion of the AC signal to the DC source.

### PRIORITY CLAIM

The present patent application is related to and claims the benefit of priority to the co-pending U.S. provisional patent application entitled, “ELECTROLYZERS PROVIDING FOR DIAGNOSTIC MEASUREMENTS DURING OPERATION”, Ser. No.: 63/781,382, Filed: 1 Apr. 2025, which is incorporated in its entirety herewith to the extent not inconsistent with the description herein.

### BACKGROUND

### Technical Field

The present disclosure relates to electrolyzers and more particularly to improving diagnostic measurements during operation of electrolyzers.

### Related Art

Electrolyzers are used for the production of hydrogen (H₂) through water electrolysis as is well known in the relevant arts. An electrolyzer typically contains multiple electrolyzer cells (provided as one or more electrolyzer stacks), with each cell producing hydrogen at the cathode and oxygen at anode by passing an electric current through water, as is also well known in the relevant arts.

Diagnostic measurements are used to evaluate the condition and performance of an electrolyzer. These measurements include diagnostic parameters such as ohmic resistance, charge transfer resistance, mass transport limitations, and capacitance. High-frequency resistance (HFR) and electrochemical impedance spectroscopy (EIS) are commonly used techniques to characterize these parameters. In-line resistance and capacitance measurements refer to diagnostic techniques that allow in situ, real-time monitoring of the performance of an electrolyzer. These diagnostic measurements help assess performance, durability, and efficiency of the electrolyzer.

Prior attempts of diagnostic measurements during production of H₂ resulted in substantive errors in measurements of capacitance and resistance. Aspects of the present disclosure are directed to improving the accuracy of diagnostic measurements during H₂ production.

### BRIEF DESCRIPTION OF THE VIEWS OF DRAWINGS

Example embodiments of the present disclosure will be described with reference to the accompanying drawings briefly described below.

FIG. 1 illustrates an example environment (hydrogen production system) in which several aspects of the present disclosure can be implemented.

FIG. 2 is a drawing illustrating the details of an electrolyzer stack in an embodiment.

FIG. 3 is a drawing illustrating the details of a Proton Exchange Membrane (PEM) electrolyzer cell in an embodiment.

FIG. 4 is a block diagram illustrating the manner in which diagnostic measurements of an electrolyzer is performed in a prior approach.

FIG. 5 is a block diagram illustrating the manner in which diagnostic measurements of an electrolyzer is performed according to aspects of the present disclosure.

FIG. 6 is a circuit diagram depicting the manner in which aspects of the present disclosure are implemented in an embodiment.

FIG. 7 is a block diagram illustrating the manner in which a stack management system is implemented to provide several aspects of the present disclosure in one embodiment.

FIG. 8 depicts is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

An aspect of the present disclosure is directed to improving diagnostic measurements during operation of electrolyzers. In one embodiment, a hydrogen production system contains an electrolyzer; a direct current (DC) source to supply a DC power to the electrolyzer to cause production of hydrogen by the electrolyzer; a test source to apply an alternating current (AC) signal across the electrolyzer to perform measurement of a diagnostic parameter of the electrolyzer; and a filter located in a path between the DC power source and the electrolyzer, the filter designed to block the AC signal from flowing back through the DC power source when the AC signal is applied across the electrolyzer. As such the test source is operable to perform the measurement during the production of the hydrogen while the filter prevents the diversion of the AC signal to the DC power source.

According to another aspect of the present disclosure, the filter operates to pass through the DC current from the DC power source, while also providing a high AC impedance that blocks the AC signal through the filter, thereby directing the AC signal from the test source to flow through the electrolyzer.

According to one more aspect of the present disclosure, the filter is implemented as an inductor having significantly more impedance than that of the electrolyzer, wherein a magnitude of the inductor is chosen to reduce the error that occurs due to the AC signal diverting into the DC power source.

According to yet another aspect of the present disclosure, the inductor offers an impedance equal to 2*π*f*L_{filter}, wherein, f is the frequency of the AC signal, and L_{filter} represents the magnitude of the inductor.

According to an aspect of the present disclosure, the test source contains an AC current source connected in parallel to the electrolyzer, an ammeter and a voltmeter, wherein upon applying currents to the electrolyzer, a stack impedance is determined based on a measured voltage (Vₜₑₛₜ) and a measured current (Iₜₑₛₜ) obtained from the voltmeter and the ammeter respectively.

According to one more aspect of the present disclosure, the electrolyzer is one of an electrolyzer cell, a PEM (Proton Exchange Membrane) electrolyzer cell, an electrolyzer stack comprising a plurality of electrolyzer cells and a plurality of electrolyzer stacks.

Thus, aspects of the present disclosure provide a high inductive filter in the path of the DC power supply driving an electrolyzer stack. The inductive filter operates to substantially pass through the DC signal and accordingly the production of H₂ is not impacted materially by the presence of the filter. In addition, the high AC impedance forces the AC test current to flow through the electrolyzer stack, thereby enabling accurate diagnostic measurement results concurrent with the production of H₂.

Another aspect of the present disclosure is directed to performing diagnostic measurements during operation of electrochemical systems. In one embodiment, an electrochemical system contains a cell designed to produce an output based on an internal chemical reaction upon supplying of a direct current (DC) power; a DC power source to supply the DC power to the cell to cause production of the output by the cell; a test source to apply an alternating current (AC) signal across the cell to perform measurement of a diagnostic parameter of the cell; and a filter located in a path between the DC power source and the cell, the filter designed to block the AC signal when the AC signal is applied across the cell. As such, the test source is operable to perform the measurement during the production of the output while the filter prevents the diversion of the AC signal to the DC source.

According to an aspect of the present disclosure, the electrochemical system includes a control system to control the DC power source and the test source to cause concurrent supply of the DC power and the AC signal.

According to one more aspect of the present disclosure, the control system is designed to switch off the DC power source if the diagnostic parameter is determined to be outside of a range.

According to yet another aspect of the present disclosure, the cell is one of an electrolyzer cell, a PEM (Proton Exchange Membrane) electrolyzer cell, a fuel cell, a battery, a flow battery, and a supercapacitor.

One more aspect of the present disclosure is directed to performing diagnostic measurements in an electrochemical system. A control system (associated with the electrochemical system) performs the actions of: controlling a DC power source to supply DC power to a cell in the electrochemical system to cause the cell to produce an output based on an internal chemical reaction; concurrently injecting an AC signal across the cell; and measuring, based on a response to the AC signal, a diagnostic parameter of the cell.

According to yet another aspect of the present disclosure, the control system switches off the DC power source if the diagnostic parameter (being measured) is determined to be outside of a range.

Several aspects of the present disclosure are described below with reference to examples for illustration. However, one skilled in the relevant art will recognize that the disclosure can be practiced without one or more of the specific details or with other methods, components, materials and so forth. In other instances, well known structures, materials, or operations are not shown in detail to avoid obscuring the features of the disclosure. Furthermore, the features/aspects described can be practiced in various combinations, though only some of the combinations are described herein for conciseness.

### 2. Example Environment

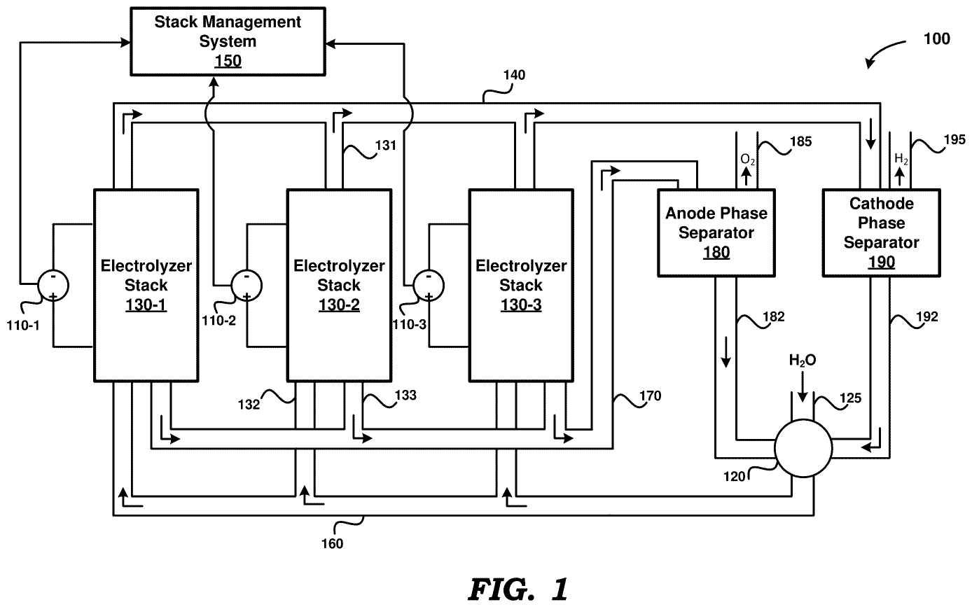

FIG. 1 illustrates an example environment (hydrogen production system) in which several aspects of the present disclosure can be implemented. Specifically, FIG. 1 shows hydrogen production system 100 containing power sources 110-1 through 110-3, water pump 120, electrolyzer stacks 130-1 through 130-3, stack management system (SMS) 150, anode phase separator 180, and cathode phase separator 190. Electrolyzer stacks 130-1 through 130-3 are individually or collectively referred to by numeral 130, as will be clear from the context. Similar convention is used for referring to other similar components as well.

Merely for illustration, only a representative number of blocks are shown in hydrogen production system 100. Many systems contain many more or smaller number of electrolyzer stacks (with a different number of electrolyzer cells described below) and other components, depending on the purpose for which the system is designed. Each block of FIG. 1 is described below in further detail.

Each of the electrolyzer stacks 130-1 through 130-3 (generally 130) is driven by a corresponding power source 110-1 through 110-3 (110) to produce a corresponding portion of hydrogen by electrolysis, as described below in further detail. Specifically, electrolyzer stack 130-2 is shown with water inlet 132 from which water is received, oxygen outlet 133 from which oxygen gas is sent along with water, and hydrogen outlet 131 from which hydrogen gas is sent also along with water. It should be noted that in the following disclosure, the term water refers to either water in liquid form or gas form (water vapor).

Though each stack is described as being powered by a corresponding power source, alternative embodiments may employ a shared power source for all or some of the stacks. In addition, practically, the content sent via oxygen outlet 133 may contain residual hydrogen, etc. The description is continued without some of such details, as not being pertinent to understanding features of the present disclosure.

Pipe 160 is used to transport water from water pump 120 to each of electrolyzer stacks 130-1 through 130-3. Pipe 140 is used to collect the mixture of hydrogen and water from the respective hydrogen outlets (131 being representative) of each electrolyzer stack 130, and transport the same to cathode phase separator 190. Pipe 170 is used to collect the mixture of oxygen and water from the respective oxygen outlets (133 being representative) of each electrolyzer stack 130, and transport the same to anode phase separator 180. It should be noted that each pipe shown in hydrogen production system 100 typically has a multi-phase flow that involves the simultaneous movement of two or more distinct phases (here gas and liquid), with these phases interacting at the end points.

Anode phase separator 180 separates oxygen from the water/oxygen mixture received from pipe 170, and releases the oxygen through output 185. The water separated in the process is released through pipe 182. Cathode phase separator 190 separates hydrogen from the water/hydrogen mixture received from pipe 140, and releases the hydrogen through output 195. The water separated in the process is released through pipe 192. The released hydrogen is dried further before being collected in suitable containers.

Water pump 120 receives water from external source 125 (when starting the electrolysis and for any short fall of water during electrolysis) and also from pipes 182 and 192, and supplies the requisite water to each of the electrolyzer stacks 130 via pipe 160. The water may be processed for purification, etc., in a known way, before being supplied to electrolyzer stacks 130 via pipe 160.

Stack management system (SMS) 150 controls various components of FIG. 1 as required for production of hydrogen. Only the connection to power sources 110 is shown for illustration, though SMS 150 may be connected to other components at least to coordinate the activities of hydrogen production system 100. In one embodiment, SMS 150 controls the operation of power sources 110 to regulate the voltage and current sent to each of electrolyzer stacks 130. Such power based control may ensure that the electrolyzer stacks operate at their peak efficiency, maximizing hydrogen production per unit of electricity consumed. SMS 150, anode phase separator 180 and cathode phase separator 190 may be implemented in a known way.

The description is continued with respect to the details of an electrolyzer stack in one embodiment.

### 3. Electrolyzer Stack

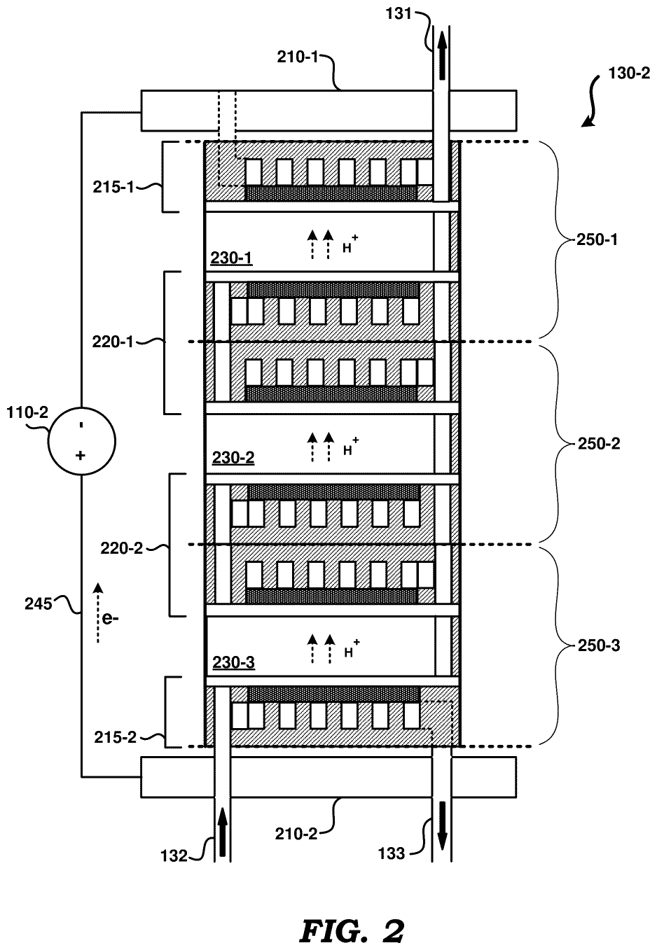

FIG. 2 is a drawing illustrating the details of an electrolyzer stack (assumed to be 130-2) in an embodiment. Electrolyzer stack 130-2 is shown containing three cells 250-1 through 250-3, between end plates 210-1 and 210-2. The three cells are shown realized by monopolar plates 215-1 and 215-2, and bipolar plates 220-1 and 220-2 and membrane electrode assemblies (MEA) 230-1 through 230-3.

Specifically, cell 250-1 is constituted of monopolar plate 215-1 (acting as cathode), MEA 230-1 and upper side of bipolar plate 220-1 (acting as anode). Cell 250-2 is constituted of lower side of bipolar plate 220-1 (acting as cathode), MEA 230-2 and upper side of bipolar plate 220-2 (acting as anode). Cell 250-3 is constituted of lower side of bipolar plate 220-2 (acting as cathode), MEA 230-3 and monopolar plate 215-2 (acting as anode). However, it may be readily appreciated that the cells can be realized based on monopolar plates (instead of using bipolar plates) alone in alternative embodiments.

Power source 110-2 provides the required potential difference to drive the electrolysis reaction between the anode(s) and the cathode(s) in the stack. Power source 110-2 may provide a current (formed by electrons e−) via external circuit 245. End plates 210-1 and 210-2 provide structural support and electrical connections at the ends of the stack.

Bipolar plates 220-1 and 220-2 separate individual cells in the stack while providing anode and cathode functionality to adjacent cells, as noted above. The plates are also used for distributing water to and from the anode(s), ensuring electrical connectivity between cells, and facilitating gas flow (oxygen and hydrogen) and heat transfer. Monopolar plate 215-1 allows hydrogen gas to leave the cathode and monopolar plate 215-2 allows oxygen gas to leave the anode. Bipolar plates 220 and monopolar plates 215 are often made of titanium or carbon-based materials, as is well known in the arts.

MEA 230 enables the electrochemical process that splits water into hydrogen and oxygen, and typically consists of a membrane, catalyst layers, and gas diffusion layers. The thin membrane allows the passage of some charged particles/ions (such as positively charged hydrogen ions/protons) while acting as an insulator for other particles/ions (such as electrons). Catalyst layers are thin layers containing electrocatalysts that facilitate the electrochemical reactions at the anode and cathode. Gas diffusion layers are porous layers that facilitate the transport of gases (oxygen and hydrogen) to and from the catalyst layers.

It may be appreciated that the above noted components may be used to implement different types of electrolysis processes such as Alkaline water electrolysis, Proton Exchange Membrane Electrolysis (PEM), Solid Oxide Electrolysis (SOEC) and Anion Exchange Membrane (AEM) Electrolysis.

In an embodiment described herein, the membrane in MEA 230 is a proton exchange membrane (PEM) which is typically made of a solid polymer electrolyte. PEM allows hydrogen ions (protons), but not electrons, to pass through from anode(s) to cathode(s). PEM electrolysis employs noble metal catalysts, typically using Iridium (IrO2) at the anode and platinum (Pt black) at the cathode.

Thus, each of cells 250 represents a single PEM cell that performs the splitting of water into hydrogen and oxygen. The operational view of a single PEM cell is described next.

### 4. PEM Electrolyzer Cell

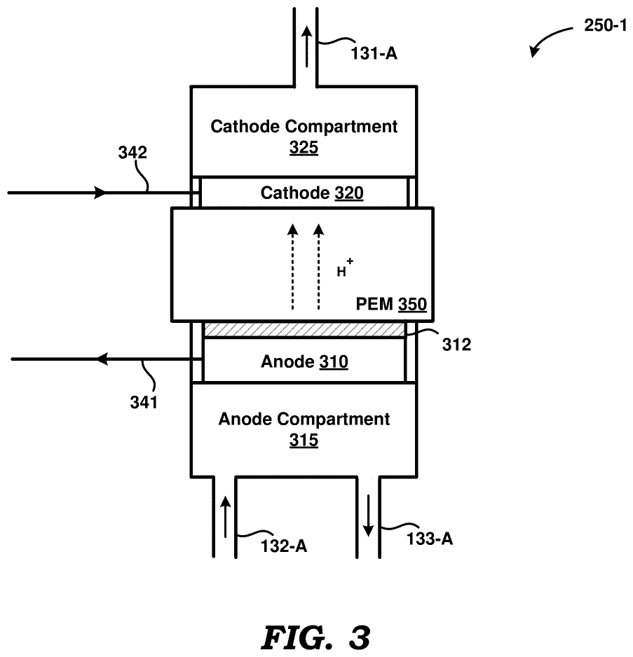

FIG. 3 is a drawing illustrating the details of a Proton Exchange Membrane (PEM) electrolyzer cell in an embodiment. PEM electrolyzer cell 250-1 is shown containing anode 310, catalyst 312, anode compartment 315, cathode 320, cathode compartment 325, PEM 350, electrical connections 341 and 342 (driven by power source 110-2), anode inlet 132-A, anode outlet 133-A and cathode outlet 131-A. Each block of FIG. 3 is described below in further detail.

At anode compartment 310, water (H2O) is received via inlet 132-A (a part of 132). Within the anode compartment 310, anode 310 facilitates oxidation of the water molecules, thereby splitting the water molecules into protons (H⁺ ions), electrons (e⁻) , and oxygen gas (O₂). Also, it is noted that the oxygen gas generated at anode 310 is a byproduct of PEM electrolyzer cell 250-1.

Catalyst 312 increases the oxidation of water molecules at anode 310 and/or lowers the energy requirements for such oxidation, as is well known in the arts. Catalyst 312 is typically composed of metal-oxide based catalysts such as iridium oxide (IrO₂), ruthenium oxide (RuO₂), or iridium ruthenium oxide (IrRuOx). Electrons generated at anode 310 are directed through an external circuit (provided via electrical connections 341 and 342) to cathode 320.

PEM 350 allows only protons to pass through, preventing gas mixing between the anode compartment 315 and cathode compartment 325. Cathode 320 combines protons with electrons to form hydrogen gas (H₂), which exits the cathode compartment 325 through outlet 131-A (a part of 131). Simultaneously, a gas mixture composed of oxygen gas generated at anode 310, hydrogen gas due to crossover through the PEM 350, and water is sent out via outlet 133-A (part of 133). Electrical connections 341 and 342 (driven by power source 110-2) provide the required potential difference to drive the electrolysis reaction between anode 310 and cathode 320. Thus, PEM electrolyzer cell 250-1 is designed to operate as part of an electrochemical system designed to produce hydrogen gas (H₂) through water electrolysis.

As noted in the Background, diagnostic measurements are commonly used to evaluate the condition and performance of an electrolyzer. The manner in which such diagnostic measurements is performed in a prior approach is described in detail below.

### 5. Prior Diagnostic Measurement

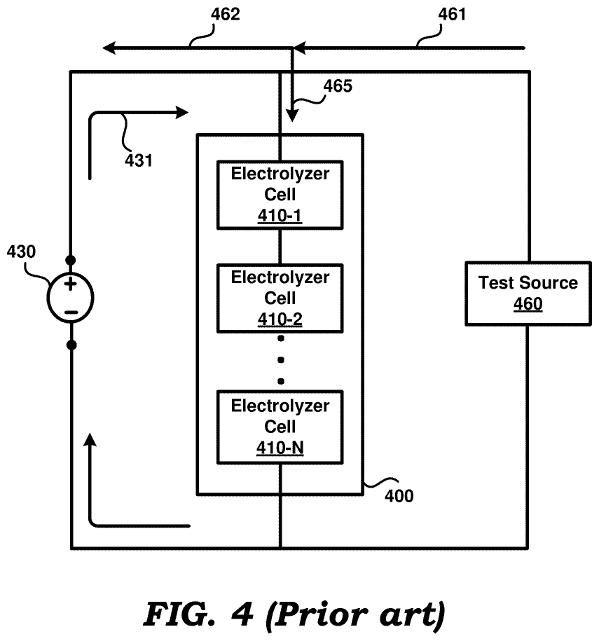

FIG. 4 is a block diagram illustrating the manner in which diagnostic measurements of an electrolyzer is performed in a prior approach. Specifically, the manner in which diagnostic measurements are performed in an electrolyzer stack 400 (containing multiple electrolyzer cells 410-1, 410-2, . . . 410-N connected in series) is described in detail below. Electrolyzer stack 400 may correspond to the single electrolyzer stack 130-2 shown in FIG. 2.

Though described below with respect to an electrolyzer stack, it may be appreciated that the aspects of the present disclosure may also be applied to a set of electrolyzer stacks (such as 130-1 through 130-3 of FIG. 1) or a single electrolyzer cell (such as PEM cell 250-1 of FIG. 3), as will be apparent to one skilled in the relevant arts by reading the disclosure herein.

DC (direct current) power source 430 is designed to supply a DC power across electrolyzer stack 400. As described above, when electrolyzer stack 400 is provided a DC current 431 from DC power source 430, and supplied with water, electrolyzer 400 produces hydrogen.

Test source 460 operates to perform diagnostics measurements. Specifically, test source 460 controls the magnitude and timing of driving of AC signals (current 461), and examines the output signal to perform diagnostic measurements using techniques such as High-frequency resistance (HFR) and electrochemical impedance spectroscopy (EIS), as is well known in the relevant arts.

In a prior approach, test source 460 performs measurements only when hydrogen is not being produced by electrolyzer 400. If the measurements are sought to be performed concurrent with hydrogen production, the AC signal (461, Iₜₑₛₜ) generated by the test source 460, that is intended to flow only into the electrolyzer stack (400), gets partially diverted into the DC power supply (current 462, Iₑᵣᵣₒᵣ), causing an error in the measurement of the stack impedance since only a portion (current 465, Iₜₑₛₜ−Iₑᵣᵣₒᵣ) of the AC signal flows through electrolyzer stack 400. This error can be significant since the impedance of the power supply (430) can be low relative to the impedance of the electrolyzer stack (400).

The description is continued with respect to the manner in which the embodiment of FIG. 4 can be extended in accordance with features of the present disclosure to address at least the above noted problem.

### 6. Improving Accuracy of Diagnostic Measurements

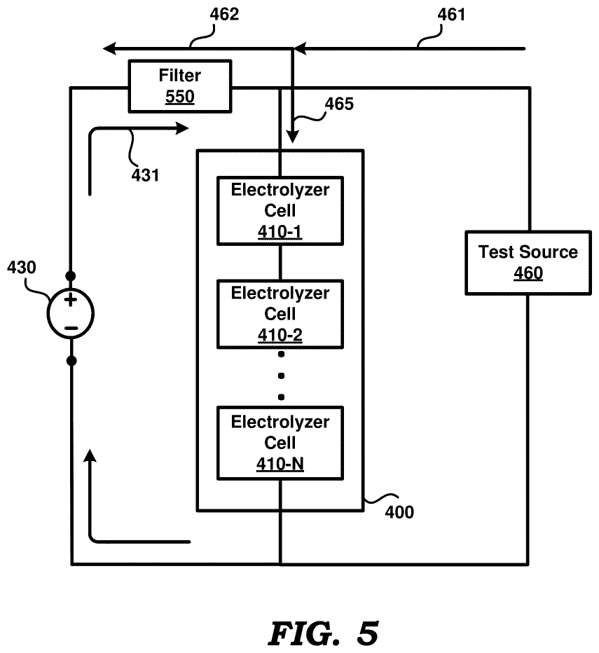

FIG. 5 is a block diagram illustrating the manner in which diagnostic measurements of an electrolyzer is performed according to aspects of the present disclosure. The components of FIG. 4 are shown repeated, but with an additional filter 550 shown connected between electrolyzer stack 400 and DC power source 430.

Filter 550, provided according to an aspect of the disclosure, operates to pass through a DC current (431) from DC power source 430, while blocking the AC test current through it (specifically current 462 to make Iₑᵣᵣₒᵣ~0), thereby directing the AC test current (from test source 460) to flow (exclusively as current 465~Iₜₑₛₜ) through electrolyzer stack 400. Such a setup with filter 550 enables accurate diagnostic measurement results concurrent with the production of H₂.

In one embodiment, filter 550 is implemented as an inductor having significantly more inductance (e.g., 10 to 100 times) than that of electrolyzer stack 400. However, in alternative embodiments, filter 550 can be implemented with desired inductive impedance using other configurations as well to obtain a desired attenuation/blocking of the AC signal.

In effect, for the operation for circuits with a DC power supply, the impedance is equal to zero and the inductor has no impact on the DC output of the power supply (430). However, when the circuit has AC signals (for diagnostics), the inductor impedance increases proportionally to frequency. The inductor magnitude is chosen to reduce the error that occurs due to the AC current 461 flowing into the DC power supply (leading to an inaccurate measurement of the electrolyzer stack impedance) to an acceptable level.

Accordingly, the diagnostics of electrolyzer can be performed accurately concurrent (i.e., simultaneously) with production of H₂. The manner in which test source 460 and filter 550 is implemented in one embodiment is described below with examples.

### 7. Sample Implementation

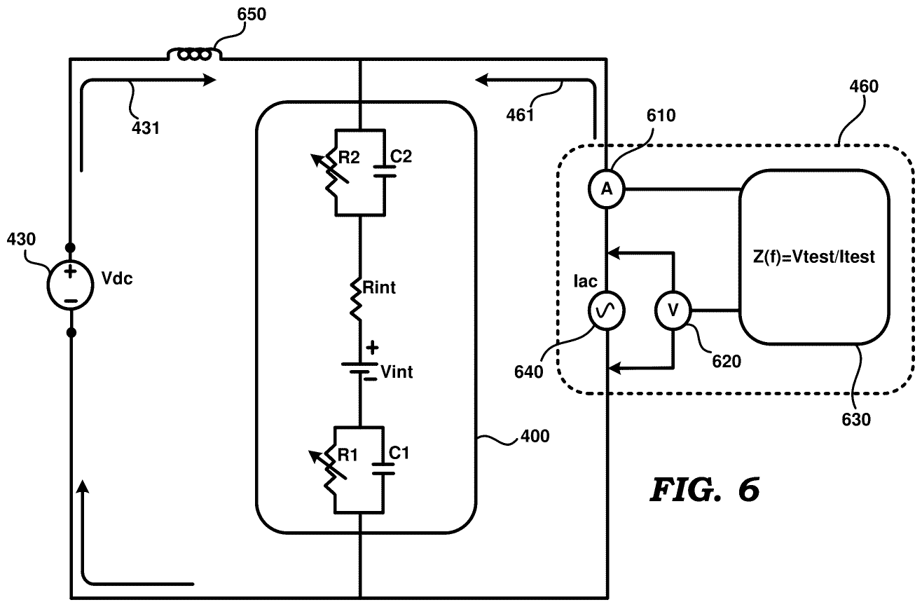

FIG. 6 is a circuit diagram depicting the manner in which aspects of the present disclosure are implemented in an embodiment. As may be readily observed, filter 550 is shown realized as inductor 650, in series with the DC power source 430, providing high impedance to AC signals. The impedance of the inductor is set equal to:

$$2 * π * f * {L}_{filter} ,$$

Where,
   F is the frequency of the AC signal,
   L_{filter} represents the magnitude of the inductor.

For DC, the impedance is equal to zero and the inductor has no impact on the DC output of the power supply. For AC signals like the test waveforms, the inductor impedance increases proportionally to frequency.

Electrolyzer stack 400 is represented as a series combination of resistance and capacitance, accounting for the ohmic resistance and capacitance of the stack. Thus, the combination of R1 and C1 represents an anode (effectively of the electrolyzer), R2 and C2 represents a cathode, Rᵢₙₜ represents the membrane resistance. Specifically, R1 represents the charge transfer resistance and C1 represents the capacitance at the anode where water oxidation occurs. R2 represents the charge transfer resistance and C2 represents the capacitance at the cathode where hydrogen evolution takes place. The electrolyzer has an internal ohmic resistance Rᵢₙₜ which reproduces the losses in the membrane. DC sink (Vᵢₙₜ) represents the electrochemical energy conversion mechanism of the electrolyzer stack.

DC power source 430 is shown represented as an ideal voltage source (V_{dc}) and provides electrical power to electrolyzer stack 400 for the purpose of generating hydrogen. Test source 460 is shown containing current source I_{ac} 640 (connected parallel to the electrolyzer stack 400), ammeter 610 and voltmeter 620. Upon applying AC current of a specific magnitude, the voltage and current (characterizing the stack) are accordingly measured.

The measured voltage and current may be used to calculate various diagnostic parameters such as ohmic resistance, charge transfer resistance, mass transport limitation, and capacitance, in any of known ways. Such measurements are also used to detect degradation, flooding, or drying in the electrolyzer stack 400.

In order to characterize the stack in terms of its capacitance and resistance, currents are applied to the stack. The stack impedance Z(f) 630 is determined based on the measured voltage (Vₜₑₛₜ) and current (Iₜₑₛₜ) obtained from voltmeter 620 and ammeter 610, respectively. This may be done at one frequency to test (High Frequency Resistance or HFR), or over a frequency range to test (Electro Impedance Spectroscopy or EIS) as will be apparent to one skilled in the relevant arts. A brief description on Electrochemical Impedance Spectroscopy (EIS) is provided below.

### 8. Electrochemical Impedance Spectroscopy (EIS)

EIS is a technique used to measure the resistance (impedance) of an electrochemical system, like electrolyzers, batteries, fuel cells, or corrosion coatings. A small AC voltage is applied to the electrochemical system over a range of frequencies. The system responds to this AC signal by generating a current, which can vary depending on the frequency and the properties of the material (such as resistance, capacitance, or inductance). The impedance is recorded at different frequencies. Impedance is the opposition to current flow in response to the AC signal. The impedance depends on how easily ions or electrons move in the electrochemical system. By analyzing how the impedance changes with frequency, valuable information about the system's characteristics (like resistance, capacitance, charge transfer, and diffusion) can be determined.

It may be appreciated that EIS helps understand the internal processes happening inside electrochemical systems without damaging them. The response of an AC signal in EIS to different electrical properties—such as resistance, capacitance, and inductance—varies depending on how these components react to alternating current at different frequencies. A sample breakdown is provided below:
1. Resistance (R)
   Behavior: Resistance (also called ohmic resistance) opposes the flow of both direct current (DC) and alternating current (AC) equally at all frequencies.
   AC Response: The impedance of a resistor is constant and does not change with frequency. In the context of EIS, the impedance due to resistance is simply: Z(R)=R where Z(R) is the impedance of the resistor.
   Phase Shift: There is no phase shift between the voltage and the current. They are perfectly in sync (0° phase shift).
2. Capacitance (C)
   Behavior: A capacitor stores a charge and its impedance decreases as the frequency of the AC signal increases. At high frequencies, capacitors allow current to pass more easily, while at low frequencies, they oppose current flow.
   AC Response: The impedance of a capacitor is inversely proportional to frequency: Z(C)=1/jωC where Z(C) is the impedance of the capacitor, ω is the angular frequency (2π×frequency, C is the capacitance, and j is the imaginary unit (indicating a 90° phase shift).
   Phase Shift: Capacitors cause a 90° phase shift, meaning the current leads the voltage by 90°. This happens because capacitors delay voltage changes while current flows immediately.
3. Inductance (L)
   Behavior: An inductor stores energy in a magnetic field and its impedance increases as the AC frequency increases. At low frequencies, inductors allow current to pass easily, but at high frequencies, they strongly oppose it.
   AC Response: The impedance of an inductor is directly proportional to frequency: Z(L)=jωL Where Z(L) is the impedance of the inductor, L is the inductance, and ω is the angular frequency.
   Phase Shift: Inductors cause a 90° phase shift, but in the opposite direction to capacitors: the voltage leads the current by 90°, meaning that the inductor delays the current relative to the voltage.

In EIS, a system often consists of combinations of these elements (resistors, capacitors, inductors), and the way the impedance changes across frequencies gives insight into the system's electrochemical properties, such as charge transfer resistance, diffusion, and double-layer capacitance. This happens by analyzing the impedance response of a system over a range of frequencies. Each of these processes affects the system's impedance in different ways, and their characteristics can be interpreted from the Nyquist and Bode plots generated during an EIS experiment.

Some of the information that may be revealed using EIS is described below:
1. Charge Transfer Resistance (Rₜ)

Charge transfer resistance refers to the resistance encountered by electrons during the redox reactions at the electrode-electrolyte interface. It is directly related to how easily a chemical reaction occurs at the surface of an electrode.

How EIS detects it: At medium frequencies, the semicircle observed in the Nyquist plot (real part of impedance vs. imaginary part) represents the charge transfer resistance. The diameter of this semicircle equals RtR_tRt, the charge transfer resistance. The larger the diameter, the greater the resistance, indicating that the reaction proceeds more slowly (less electron transfer). On the Bode plot (frequency vs. impedance), the charge transfer resistance appears as a plateau at medium frequencies where the impedance is relatively constant.
2. Diffusion (Warburg Impedance)

Diffusion (also called mass transport) refers to the movement of ions or molecules in the electrolyte to or from the electrode. When diffusion limits the reaction rate, it creates what's known as Warburg impedance.

How EIS detects it: At low frequencies, diffusion becomes significant because the ions take longer to move to or away from the electrode. In the Nyquist plot, this appears as a straight line with a slope of 45°, which is the hallmark of Warburg impedance. In the Bode plot, diffusion-related processes can be observed as a sloping impedance response at low frequencies. The Warburg impedance increases at lower frequencies because diffusion becomes the rate-limiting step in these systems.
3. Double-Layer Capacitance (C_dl)

Double-layer capacitance arises from the separation of charge at the electrode-electrolyte interface, where a layer of ions forms in the solution close to the charged electrode surface. It acts like a capacitor, storing electrical charge.

How EIS detects it: At high frequencies, the impedance associated with the double-layer capacitance dominates. In the Nyquist plot, this is seen as the initial downward curve (before the semicircle), indicating capacitive behavior. In the Bode plot, the phase angle at high frequencies approaches −90°, characteristic of a capacitive response. The impedance (magnitude) at high frequencies decreases because capacitors allow AC current to pass more easily at higher frequencies. The capacitance can be calculated from the frequency range over which the capacitive behavior is observed, providing insight into the properties of the double-layer and surface area of the electrode.

Together, these EIS insights may help scientists and engineers understand the kinetics and dynamics of electrochemical systems, such as electrolyzers (400), batteries, fuel cells, corrosion, or sensors, and can be used to optimize their performance.

Though disclosed above with respect to electrolyzers, it may be appreciated that the techniques noted above may be applied to various electrochemical systems including fuel cells, batteries, super capacitors and flow batteries, enhancing diagnostic capabilities across multiple domains. In general, each of these electrochemical systems are designed to general corresponding outputs (hydrogen gas/power in case of electrolyzer/fuel cells respectively) based on a respective internal chemical reaction when a DC power is applied. For example, the techniques disclosed herein may be used for in-situ impedance monitoring during load operation in fuel cells, and in batteries, for BMS systems performing EIS during charging/discharging.

It may be noted that flow batteries and supercapacitors also have a similar AC/DC coexistence problem. The techniques disclosed herein operates without compromising the functionality of the DC power supply or affecting the normal operations of the electrochemical systems. The inductive filtering dynamically adjusts based on the HFR or EIS frequency through software control, ensuring the inductive impedance remains significantly higher than the stack impedance at any frequency, which enhances measurement accuracy.

According to an aspect, the various components of the present disclosure (such as DC power source, test source, filter, etc.) are provided as part of stack management system 150 shown in FIG. 1, as described in detail below.

### 9. Stack Management System

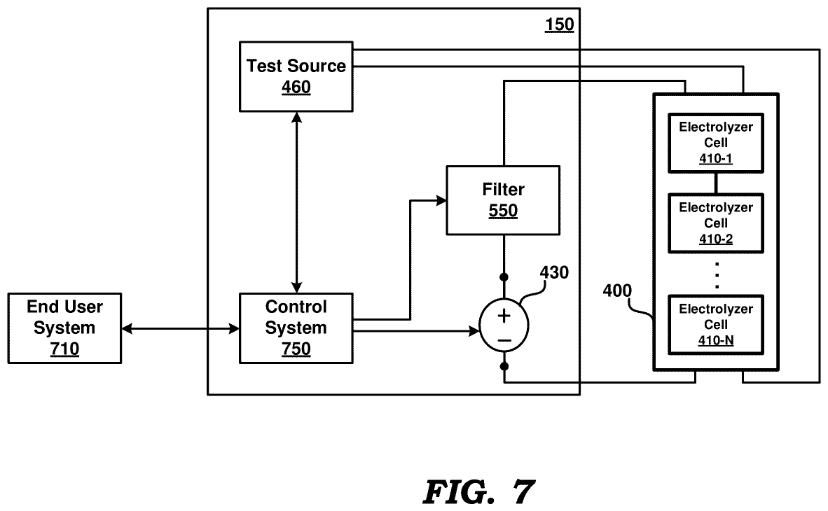

FIG. 7 is a block diagram illustrating the manner in which a stack management system (150) is implemented to provide several aspects of the present disclosure in one embodiment. Stack management system (SMS) 150 is shown containing DC power source 430, test source 460 and filter 550 which all operate as described above. The components are shown connected to electrolyzer stack 400 similar to the connections shown in FIGS. 5 and 6. The other component of FIG. 7 are described in detail below.

End user system 710 represents a system such as a personal computer, work-station, mobile device, computing tablet etc., used by users to generate (user) requests directed to control system 150. The user requests may be generated by users using appropriate user interfaces (e.g., web pages, a native user interface, etc.). The generated user requests may be sent over a combination of wired/wireless networks (not shown) to control system 150.

In general, end-user system 710 requests control system 150 for performing desired tasks (controlling the operation) and receives the corresponding responses (e.g., web pages) containing the results of performance of the requested tasks. The web pages/responses may then be presented to a user by a client application such as the browser, as is well known in the relevant arts.

Control system 750 controls the operation of the other components in SMS 150 based on the tasks/inputs received from end user system 710. According to an aspect, control system 750 controls DC power source 430 to supply DC power to electrolyzer stack 400 to cause the stack to generate hydrogen gas, while concurrently injecting an AC signal across the stack using test source 460 and measuring, based on a response to the AC signal, a diagnostic parameter of the stack (400). Control system 750 may send appropriate signals to DC power source 430, test source 460 and filter 550 for performing these actions, as will be apparent to one skilled in the relevant arts.

Control system 750 may also send control signals to test source 460 to specify the instantaneous frequencies of the AC signal that are to be applied across electrolyzer stack 400 for performing EIS noted above. In an embodiment, filter 550 is tunable to specific inductance with appropriate software commands, and control system 750 may issue such software commands also in the EIS process.

According to another aspect, control system 750 switches off DC power source 430 if the diagnostic parameter (being measured) is determined to be outside of a range. Thus, various aspects of the present disclosure are provided by stack management system 150.

The present disclosure addresses a critical challenge in electrolyzer diagnostic measurements by introducing an innovative inductive filtering mechanism. By directing AC signals exclusively through the electrolyzer stack (400), the approach ensures accurate high-frequency resistance measurements and EIS diagnostics. Such a solution offers flexibility, accuracy, and adaptability, making it useful for researchers and industry professionals working with electrolyzers and other electrochemical systems.

The ability of the instant disclosure to deliver precise diagnostics without interrupting operational processes represents a significant step forward in electrochemical system analysis and optimization. Some of the advantages of the present disclosure is described in detail below.

### 10. Advantages

The disclosed technique herein provides true resistance measurements of an electrolyzer (such as 400) by eliminating signal sharing inaccuracies even when the measurements are performed concurrent with production of hydrogen. Thus, the present disclosure facilitates continuous, real-time high-frequency resistance or EIS measurements without disconnecting or pausing the DC power supply. Such an approach enables simultaneous use of an external power supply for system power while performing precise diagnostic measurements.

The current system is also non-intrusive, does not interfere with the ability of the DC power source (430) to deliver power to the electrolyzer stack, allowing continuous operation during diagnostics.

Another advantage of the instant disclosure is dynamic frequency adaptation. The inductive filtering (650) dynamically adjusts based on the HFR or EIS frequency by coupling the frequency and inductive filtering through software control. This ensures that at any frequency, the inductive resistance remains significantly higher than the AC signal, enhancing measurement accuracy.

One more advantage of the instant disclosure is in-situ real-time monitoring. The system enables continuous diagnostic measurements without the need to disconnect or pause the DC power supply.

Yet another advantage is that the instant disclosure facilitates monitoring of electrolyzer stack health during field operation (deployment at customer sites). Such a monitoring ability over years of operation facilitates timely preventative maintenance of the system, and optimum performance.

It should be further appreciated that the features described above can be implemented in various embodiments as a desired combination of one or more of hardware, software, and firmware. The description is continued with respect to an embodiment in which various features are operative when the software instructions described above are executed.

### 11. Digital Processing System

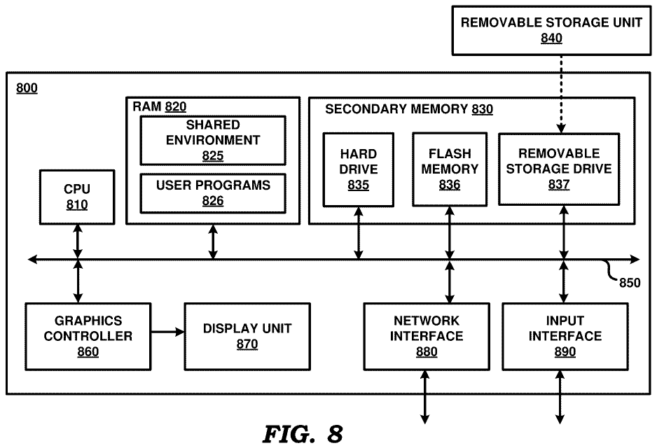

FIG. 8 is a block diagram illustrating the details of digital processing system 800 in which various aspects of the present disclosure are operative by execution of appropriate executable modules. Digital processing system 800 may correspond to end user system 710 or control system 750.

Digital processing system 800 may contain one or more processors such as a central processing unit (CPU) 810, random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions constituting shared environment 825 and/or other user programs 826 (such as other applications, DBMS, etc.). In addition to shared environment 825, RAM 820 may contain other software programs such as device drivers, virtual machines, etc., which provide a (common) run time environment for execution of other/user programs.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) and may be used to provide inputs. Network interface 880 provides connectivity to a network (e.g., using Internet Protocol), and may be used to communicate with other systems connected to the networks.

Secondary memory 830 may contain hard drive 835, flash memory 836, and removable storage drive 837. Secondary memory 830 may store the data (e.g., measured values of diagnostic parameters, frequencies for the AC signal) and software instructions (e.g., for providing control signals to other components of FIG. 7), which enable digital processing system 800 to provide several features in accordance with the present disclosure. The code/instructions stored in secondary memory 830 may either be copied to RAM 820 prior to execution by CPU 810 for higher execution speeds, or may be directly executed by CPU 810.

Some or all of the data and instructions may be provided on removable storage unit 840, and the data and instructions may be read and provided by removable storage drive 837 to CPU 810. Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 850. Transmission media can also take the form of acoustic or light waves, such as those generated during radio-wave and infra-red data communications.

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 12. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A hydrogen production system comprising:
an electrolyzer;
a direct current (DC) power source to supply a DC power to said electrolyzer to cause production of hydrogen by said electrolyzer;
a test source to apply an alternating current (AC) signal across said electrolyzer to perform measurement of a diagnostic parameter of said electrolyzer; and
a filter located in a path between said DC power source and said electrolyzer, said filter designed to block said AC signal when said AC signal is applied across said electrolyzer,
whereby said test source is operable to perform said measurement during said production of said hydrogen while said filter prevents the diversion of said AC signal to said DC source.

2. The hydrogen production system of claim 1, wherein said filter operates to pass through a DC current from said DC power source, while also providing a high AC impedance that blocks said AC signal to pass through said filter, thereby directing said AC signal from said test source to flow through said electrolyzer.

3. The hydrogen production system of claim 2, wherein said filter is implemented as an inductor having significantly more inductance than that of said electrolyzer,
wherein a magnitude of said inductor is chosen to be at least ten times the inductance of said electrolyzer to reduce the error that occurs due to said AC signal diverting into said DC power source.

4. The hydrogen production system of claim 3, wherein said inductor offers an impedance equal to:
$$2 * π * f * {L}_{filter} ,$$
wherein,
f is the frequency of the AC signal, and
L_{filter} represents said magnitude of said inductor.

5. The hydrogen production system of claim 4, wherein said test source comprises:
an AC current source connected in parallel to said electrolyzer;
an ammeter; and
a voltmeter;
wherein upon applying AC currents by said AC current source to said electrolyzer, a stack impedance is determined based on a measured voltage (Vₜₑₛₜ) and a measured current (Iₜₑₛₜ) obtained from said voltmeter and said ammeter respectively.

6. The hydrogen production system of claim 1, wherein said diagnostic parameter is selected from ohmic resistance, charge transfer resistance, mass transport limitation, and capacitance.

7. The hydrogen production system of claim 6, wherein said measurement is used to detect degradation, flooding, or drying in said electrolyzer.

8. The hydrogen production system of claim 7, wherein said electrolyzer is one of an electrolyzer cell, a PEM (Proton Exchange Membrane) electrolyzer cell, an electrolyzer stack comprising a plurality of electrolyzer cells and a plurality of electrolyzer stacks.

9. An electrochemical system comprising:
a cell designed to produce an output based on an internal chemical reaction upon supplying of a direct current (DC) power;
a DC power source to supply said DC power to said cell to cause production of said output by said cell;
a test source to apply an alternating current (AC) signal across said cell to perform measurement of a diagnostic parameter of said cell; and
a filter located in a path between said DC power source and said cell, said filter designed to block said AC signal when said AC signal is applied across said cell,
whereby said test source is operable to perform said measurement during said production of said output while said filter prevents the diversion of said AC signal to said DC source.

10. The electrochemical system of claim 9, further comprising a control system to control said DC power source and said test source to cause concurrent supply of said DC power and said AC signal.

11. The electrochemical system of claim 10, wherein said control system is designed to switch off said DC power source if said diagnostic parameter is determined to be outside of a range.

12. The electrochemical system of claim 11, wherein said cell is one of an electrolyzer cell, a PEM (Proton Exchange Membrane) electrolyzer cell, a fuel cell, a battery, a flow battery, and a supercapacitor.

13. The electrochemical system of claim 9, wherein said filter is implemented as an inductor having significantly more inductance than that of said cell,
wherein a magnitude of said inductor is chosen to be at least ten times the inductance of said cell to reduce the error that occurs due to said AC signal diverting into said DC power source.

14. The electrochemical system of claim 13, wherein said test source comprises:
an AC current source connected in parallel to said cell;
an ammeter; and
a voltmeter;
wherein upon applying AC currents by said AC current source to said cell, a stack impedance is determined based on a measured voltage (Vₜₑₛₜ) and a measured current (Iₜₑₛₜ) obtained from said voltmeter and said ammeter respectively.

15. The electrochemical system of claim 14, wherein said diagnostic parameter is selected from ohmic resistance, charge transfer resistance, mass transport limitation, and capacitance.

16. The electrochemical system of claim 15, wherein said measurement is used to detect degradation, flooding, or drying in said cell.

17. A non-transitory machine-readable medium storing one or more sequences of instructions for performing diagnostic measurements in an electrochemical system, wherein execution of said one or more instructions by one or more processors contained in a control system associated with said electrochemical system causes said control system to perform the actions of:
controlling a DC power source to supply DC power to a cell in said electrochemical system to cause said cell to produce an output based on an internal chemical reaction;
concurrently injecting an AC signal across said cell; and
measuring, based on a response to said AC signal, a diagnostic parameter of said cell.

18. The non-transitory machine-readable medium of claim 17, further comprising switching off said DC power source if said diagnostic parameter is determined to be outside of a range.

19. The non-transitory machine-readable medium of claim 18, wherein said diagnostic parameter is selected from ohmic resistance, charge transfer resistance, mass transport limitation, and capacitance,
wherein said measuring is used to detect degradation, flooding, or drying in said cell.

20. The non-transitory machine-readable medium of claim 19, wherein said cell is one of an electrolyzer cell, a PEM (Proton Exchange Membrane) electrolyzer cell, a fuel cell, a battery, a flow battery, and a supercapacitor.
